(19) United States
(12) Patent Application Publication
(10) Pub. No.: US 2026/0246874 A1
(43) Pub. Date: Aug. 20, 2026

(54) STORAGE MEDIUM, INFORMATION PROCESSING APPARATUS, AND FAX TRANSMISSION METHOD

(71) Applicant: SEIKO EPSON CORPORATION, Tokyo (JP)

(72) Inventor: Tomoki MATSUZAWA, Shiojiri (JP)

(21) Appl. No.: 19/541,789

(22) Filed: Feb. 17, 2026

(30) Foreign Application Priority Data
Feb. 19, 2025 (JP) 2025-024862

(51) Int. Cl. H04N 1/00

(52) U.S. Cl. CPC H04N 1/00206; H04N 1/00244; H04N 2201/0094

(57) ABSTRACT

A non-transitory computer-readable storage medium stores a print control program that causes a computer to execute a first process, a second process, and a transmission process. In the first process, a transmission setting value of a fax is acquired from a generic printer driver. In the second process, capability information of the image processing device that is implementable using a first protocol is acquired from the image processing device having a fax transmission function. In the transmission process, when the capability information indicates that data transmission using the first protocol is possible, first data including at least the transmission setting value is transmitted to the image processing device using the first protocol. When the capability information indicates that data transmission using the first protocol is not possible, the first data is transmitted to the image processing device using a second protocol defined by the vendor of the image processing device.

The present application is based on, and claims priority from JP Application Serial Number 2025-024862, filed February 19, 2025, the disclosure of which is hereby incorporated by reference herein in its entirety.

### BACKGROUND

### 1. Technical Field

The present disclosure relates to a storage medium, an information processing apparatus, and a fax transmission method.

### 2. Related Art

JP-A-2019-169927 discloses a personal computer (PC) - facsimile (fax) direct transmission technique that allows document data to be directly transmitted from a terminal device, such as a PC, to a counterparty fax machine.

However, in a generic printer driver, such as an OS-standard printer driver used in the technique described in JP-A-2019-169927, only functions standardized by the IPP specification are available among fax functions, and vendor-specific functions are not available. OS stands for Operating System, and IPP stands for Internet Printing Protocol.

Therefore, in an environment in which a fax transmission process using a generic printer driver is performed, it is desirable to develop a technique that enables the use of vendor-specific functions that cannot be supported by IPP communication. In addition, the same or similar issue may occur with other standard protocols, including any that may be established in the future.

### SUMMARY

According to an aspect of the present disclosure, a non-transitory computer-readable storage medium storing a print control program that causes a computer to execute: a first acquisition process of acquiring a transmission setting value of a fax from a generic printer driver; a second acquisition process of acquiring, from an image processing device having a fax transmission function, capability information of the image processing device that is implementable using a first protocol; and a transmission process of transmitting first data including at least the transmission setting value to the image processing device, using the first protocol, when the capability information indicates that data transmission using the first protocol is possible, and transmitting the first data to the image processing device, using a second protocol defined by a vendor of the image processing device, when the capability information indicates that data transmission using the first protocol is not possible.

According to another aspect of the present disclosure, an information processing apparatus including: a generic printer driver; a first acquisition processing unit configured to acquire a transmission setting value of a fax from the generic printer driver; a second acquisition processing unit configured to acquire, from an image processing device having a fax transmission function, capability information of the image processing device that is implementable using a first protocol; and a transmission processing unit configured to, when the capability information indicates that data transmission using the first protocol is possible, transmit first data including at least the transmission setting value, using the first protocol, to the image processing device, and to, when the capability information indicates that data transmission using the first protocol is not possible, transmit the first data, using a second protocol defined by a vendor of the image processing device, to the image processing device.

According to another aspect of the present disclosure, a fax transmission method executed by a computer, including: acquiring a transmission setting value of a fax from a generic printer driver; acquiring, from an image processing device having a fax transmission function, capability information of the image processing device that is implementable using a first protocol; and transmitting first data including at least the transmission setting value to the image processing device, using the first protocol, when the capability information indicates that data transmission using the first protocol is possible, and transmitting the first data to the image processing device, using a second protocol defined by a vendor of the image processing device, when the capability information indicates that data transmission using the first protocol is not possible.

### BRIEF DESCRIPTION OF THE DRAWINGS

FIG. 1 is a block diagram illustrating a configuration example of a fax system including an information processing apparatus according to an embodiment.

FIG. 2 is a block diagram illustrating a detailed example of a portion of the fax system of FIG. 1 and illustrating an example of a configuration of the fax system that performs a first example of a fax transmission process.

FIG. 3 is a sequence diagram for explaining an example of a fax transmission process performed by the fax system of FIG. 1.

FIG. 4 is a sequence diagram for explaining the first example of the fax transmission process executed between steps S5 and S13 of FIG. 3.

FIG. 5 illustrates an example of a user interface (UI) image displayed in the fax transmission process of FIGS. 3 and 4.

FIG. 6 is a block diagram illustrating a detailed example of a portion of the fax system of FIG. 1, and illustrating a configuration example of a fax system that performs a second example of the fax transmission process.

FIG. 7 is a sequence diagram for explaining a second example of the fax transmission process executed between steps S5 and S13 of FIG. 3.

FIG. 8 is a block diagram illustrating an example of a hardware configuration of a device.

### DESCRIPTION OF EMBODIMENTS

Hereinafter, embodiments of the present disclosure will be described with reference to the drawings. The drawings are merely exemplary for explaining embodiments of the present disclosure. In addition, not all components described in the embodiments of the present disclosure are necessarily essential in the present disclosure.

### Embodiments

### System Configuration

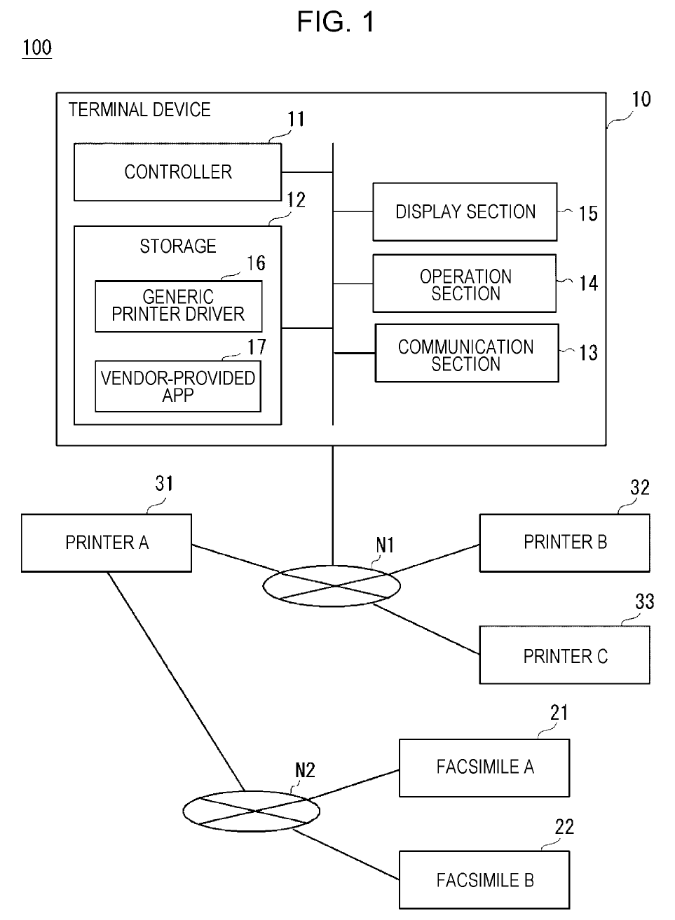

A configuration example of a fax system according to the present embodiment will be described with reference to FIG. 1. FIG. 1 is a block diagram illustrating a configuration example of a fax system according to the present embodiment.

As illustrated in FIG. 1, a fax system 100 according to the present embodiment may include a terminal device 10, facsimile A (21), facsimile B (22), printer A (31), printer B (32), and printer C (33).

The terminal device 10 is an information processing device having communication functions, such as a personal computer (PC), smartphone, or tablet terminal, and can be used by a user who desires fax transmission or printing. The terminal device 10 is connected to printer A (31), printer B (32), and printer C (33) via a network N1 to, for example, transmit a fax transmission request or a print request. The fax transmission request is a request for transmitting a fax addressed to facsimile A (21), facsimile B (22), or the like.

Although not illustrated, the fax system 100 can include a plurality of terminal devices 10. The fax system 100 is configured to be able to perform fax transmission from a printer in such a manner, and therefore can also be referred to as a fax transmission system. The fax system 100, in which printing can also be performed by a printer, may be referred to as a printing system.

Each of printer A (31), printer B (32), and printer C (33) is an example of an image processing device having a fax transmission function. Of course, the image processing device may also have a fax reception function. When receiving printing data, each of printer A (31), printer B (32), and printer C (33) can perform printing on media; however, when receiving printing data specifying the fax transmission destination, it can transmit a fax to that destination. Each printer produces printed material by performing printing, and generates transmission data, which is a transmission object, when transmitting a fax.

In addition, for the sake of convenience, a description is given on the assumption that the fax system 100 includes three printers in such a manner. However, the fax system 100 may include at least one image processing device, such as at least one printer or fax machine. In addition, each printer may be any device so long as it has a facsimile transmission function, a communication function, and a print function; however, each printer may be a multifunction printer having other functions such as a scanner function and a copying function. In addition, each printer may also be referred to as a printing device or an image forming device. In addition, a printing method in each printer is not limited, and various printing methods such as an ink jet printing method and a laser printing method are applicable.

Facsimile A (21) and facsimile B (22) are examples of a fax machine that receives a fax. Examples of the fax transmission destination from printer A (31) include, but are not limited to, the illustrated facsimile A (21) and facsimile B (22) connected to printer A (31) via a network N2. For example, when printer B (32) or printer C (33) is connected to the network N2, fax transmission can be performed from printer B (32) or printer C (33) to facsimile A (21) and facsimile B (22) as fax transmission destinations. In addition, the fax transmission destination is not limited to at least one of facsimile A (21) and facsimile B (22), and may be another fax machine (not illustrated), and the number of fax transmission destinations may be three or more. The fax machines such as facsimile A (21) and facsimile B (22) are configurable to allow for fax transmission. The network N2 is usually the public switched telephone network (PSTN).

The fax system 100 performs fax transmission from a printer selected from among printer A (31), printer B (32), and printer C (33) by a user operation from the terminal device 10 to a fax transmission destination selected by the user operation. Additionally, the fax system 100 can perform printing from a printer selected from among printer A (31), printer B (32), and printer C (33) by a user operation from the terminal device 10. Hereinafter, a configuration example of the terminal device 10 will be described in detail. A description of a configuration example of each printer and a configuration example of each fax machine will be omitted.

### Configuration of Terminal Device 10

As illustrated in FIG. 1, the terminal device 10 may include a controller 11, a storage 12, a communication section 13, an operation section 14, and a display section 15.

The controller 11 controls the entire terminal device 10. The controller 11 is configurable to include, for example, an arithmetic processing device, a working memory, and a storage device that stores a control program, parameters, and the like. The arithmetic processing device can be a central processing unit (CPU), a graphics processing unit (GPU), or the like. The controller 11 is also configurable as a system on a chip (SoC). As can be seen from these examples, the controller 11 is configurable to store the control program in an executable state. However, the controller 11 is also configurable to store a subset of the control program as a circuit configuration such as a field-programmable gate array (FPGA) or configurable as a dedicated circuit.

The above-described control program can include a program for the arithmetic processing device to execute processing related to printing in cooperation with the storage 12, the communication section 13, the operation section 14, and the display section 15. The control program may include an OS. Since the OS is an OS installed in the terminal device 10, the type of the OS depends on the model or other specifications of the terminal device 10. The control program may include a Web browser in the OS or outside the OS. Hereinafter, an example will be described in which at least a portion of the control program is stored in the storage 12 provided separately from the controller 11; however, the storage 12 may be a portion of a storage device in the controller 11. In other words, the storage 12 may also be regarded as a subset of the controller 11.

The storage 12 is, for example, a storage device such as a hard disk drive, a solid state drive, or another memory. The storage 12 stores, as the subset of the control program, a generic printer driver 16 and a vendor-provided application program 17, which will be described later, in a state executable by the controller 11. In the description given hereinafter, the application program is abbreviated as App. The storage 12 may also store various types of data, such as files to be transmitted by fax or to be printed.

The communication section 13 communicates with external devices such as printer A (31), printer B (32), and printer C (33) via the network N1 in a wireless or wired manner in compliance with predetermined communication standards, such as various mobile communication standards and Wi-Fi (registered trademark) standards. The communication section 13 can be made of one or more communication interfaces capable of performing such communication. The network N1 is typically a local area network (LAN).

The operation section 14 receives an operation by a user of the terminal device 10, and may also be referred to as an operation receiving section. The operation section 14 may be implemented by, for example, any one or more of a physical button, a touch panel mounted on the display section 15, a pointing device, and a keyboard. In a configuration in which the operation section 14 includes a touch panel, the display section 15 and the touch panel may be collectively referred to as an operation panel of the terminal device 10.

The display section 15 is a portion for displaying a user interface (UI) image for operating the terminal device 10, and is, for example, constituted by a display device such as a liquid crystal display or organic electroluminescent display. The display section 15 may be configured to include a display and a drive circuit for driving the display.

The generic printer driver 16 will be described. The generic printer driver 16 is an OS-standard printer driver, which is included in the OS included in the control program or attached to the OS. The generic printer driver 16 may be a program capable of controlling various types of printers to perform printing. The generic printer driver 16 may also be referred to as an OS generic printing program or a general-purpose printing program.

The generic printer driver 16 uses a general-purpose protocol for printer discovery and printing. A description will be given assuming that this printing includes fax transmission. The generic printer driver 16, for example, uses mDNS/DNS-SD for printer discovery and uses IPP for printing by the printer. An example of the first protocol is IPP. Here, DNS stands for Domain Name System, mDNS stands for multicast DNS, and DNS-SD stands for DNS Service Discovery. IPP stands for Internet Printing Protocol.

As can be seen from this example, the generic printer driver 16 may be, for example, IPP Class Driver. IPP is an exemplary standard protocol for controlling printer management and printing. IPP acquires and controls information on printers using POST requests and responses of Hypertext Transfer Protocol (HTTP). Using IPP, printer settings and printer state acquisition can be made. Here, use of HTTP Secure (HTTPS) instead of HTTP enables secure communication.

The vendor-provided App 17 will be described. The vendor-provided App 17 is an application program that assists the generic printer driver 16 and is used to extend the functions of the generic printer driver 16. This allows the generic printer driver 16 to have functions of activating the vendor-provided App 17 and transmitting a print job to the vendor-provided App 17. The vendor-provided App 17 may, for example, be implemented as a Print Support Application (PSA).

The vendor-provided App 17 can assist the generic printer driver 16 to constitute a program that causes a computer to execute control suitable for the performance of a target printer, that is, control for supporting functions specific to the printer. Such control includes fax transmission control, and may, of course, also include print control. The computer mentioned here refers to the terminal device 10 or the controller 11. In the present embodiment, at least an extended function of the fax transmission function is included as a function specific to the printer. In a case where the generic printer driver 16 does not support the fax transmission itself, the vendor-provided App 17 may assist the fax transmission function itself.

When the vendor-provided App 17 acquires a print job from the generic printer driver 16, the vendor-provided App 17 is capable of converting the print job such that a designated printer can perform printing or fax transmission using a function specific to the printer. Regarding fax transmission, the vendor-provided App 17 is capable of receiving fax data and transmission setting values as a print job and converting the fax data into a format that allows for fax transmission of the fax data from the printer.

The vendor-provided App 17 is an app provided by a printer vendor or the like. The vendor-provided App 17 may be provided to the user of the terminal device 10 by, for example, being made public in an application store or the like that offers the OS. Alternatively, the vendor-provided App 17 may be provided to the user by being included in or attached to the OS.

The vendor-provided App 17 includes a print control program, which will be described next. In other words, this print control program may also be implemented as, for example, a PSA. The print control program causes a computer to execute a first acquisition process, a second acquisition process, and a transmission process as described below. The computer mentioned here also refers to the terminal device 10 or the controller 11.

In the first acquisition process, fax transmission setting values are acquired from the generic printer driver 16. The items of the transmission setting values include, for example, paper size, image quality, color/monochrome, direct transmission, and memory transmission. Additionally, the vendor-provided App 17 or the generic printer driver 16 acquires a fax transmission destination, which serves as a fax destination, as one of the transmission setting values or as another value.

In order to acquire the transmission setting values or the like, in response to a request from the generic printer driver 16, the print control program may cause the display section 15 to display a setting image for setting the transmission setting values. The setting image may be a setting UI image, which is a UI image for settings. An example of the setting UI image will be described later in examples of the fax transmission process. This request is performed using inter-process communication between the generic printer driver 16 and the print control program. This request may also be performed, for example, when the generic printer driver 16 receives a user operation for displaying a setting UI image for performing detailed settings from the operation section 14.

In the second acquisition process, printer capability information that is implementable using IPP is acquired from a printer that is an example of an image processing device having a fax transmission function. This printer is a printer having a fax transmission function, which, in the example of FIG. 1, refers to a printer selected from among printer A (31), printer B (32), and printer C (33) by a user operation from the terminal device 10. The capability information mentioned above may also be referred to as information on configurable settings, and, for example, may include IPP attributes supported by a printer that performs fax transmission.

In the transmission process, when the acquired capability information indicates that IPP data transmission is possible, the first data including at least the transmission setting values is transmitted using IPP to the printer. The first data as used here may include the above-mentioned fax data, that is, fax transmission data, which is data to be transmitted by fax.

In contrast, in the transmission process, when the acquired capability information indicates that IPP data transmission is not possible, the first data is transmitted to the printer using a vendor protocol defined by the vendor of the printer. An example of the second protocol is a vendor protocol. The vendor protocol as used here may be provided by the vendor of the printer, or may be provided by a provider other than the vendor.

In the present embodiment, the transmission process includes a switch process of the transmission-related protocol according to the capability information. Accordingly, the transmission process enables the target printer to receive the first data regardless of whether IPP data transmission from outside the terminal device 10 or the like is possible, that is, whether or not IPP data reception is possible. This enables the target printer to perform fax transmission to one or more fax transmission destinations. For example, when the target printer is printer A (31) and the fax transmission destinations are facsimile A (21) and facsimile B (22), for example, the print control program can cause the first data to be transmitted to printer A (31), and printer A (31), upon receiving the first data, can perform fax transmission of the target fax data to facsimile A (21) and facsimile B (22).

Since the print control program is a program for causing fax transmission to be performed, the print control program may be referred to as a fax transmission program or a fax control program.

In other words, in the present embodiment, a computer-executed fax transmission method including the first acquisition process, second acquisition process, and third transmission process described above may be provided. This fax transmission method may be regarded as a method for performing fax transmission as a subset of print control, and may also be referred to either as a fax control method or as a print control method.

In further other words, the terminal device 10 includes the generic printer driver 16, and a first acquisition processing unit, a second acquisition processing unit, and a transmission processing unit as follows. The terminal device 10 may be referred to as a fax transmission device, a fax control device, or a print control device.

The first acquisition processing unit acquires fax transmission setting values from the generic printer driver 16. The second acquisition processing unit acquires, from an image processing device having a fax transmission function, capability information of the image processing device that is implementable using IPP. When the capability information indicates that data transmission using IPP is possible, the transmission processing unit uses IPP to transmit first data including at least the transmission setting values to the image processing device. In contrast, when the capability information indicates that data transmission using IPP is not possible, the transmission processing unit transmits the first data to the image processing device using a vendor protocol defined by a vendor of the image processing device.

### Effects of Present Embodiment

Prior to describing a more specific example of the fax transmission process in the present embodiment, the effects of the present embodiment will be described.

As described above, in the fax system 100, reception of the first data including the transmission setting values is possible regardless of whether a printer that performs fax transmission is capable of receiving data using IPP. Therefore, according to the present embodiment, even in an environment in which a fax transmission process is performed using the generic printer driver 16, it is possible to set not only transmission setting values for functions supported by IPP, among various fax functions, but also transmission setting values for many functions. This enables implementation of vendor-specific PC-fax functions. That is, according to the present embodiment, in such an environment, it is possible to support vendor-unique functions that cannot be supported by IPP communication among fax functions.

To provide supplementary explanation of such effects, the fax system according to the present embodiment will be compared with a fax system according to a comparative example. In the fax system of the comparative example, the printer is controlled using a generic printer driver incorporated as standard in Windows (registered trademark) OS instead of a printer driver provided by the vendor. Even in the comparative example, the generic printer driver uses a general-purpose protocol for printer discovery and printing. In addition, the generic printer driver of the comparative example provides a mechanism for activating a vendor-provided application program associated with the printer and customizing print settings and IPP communication during printing.

Of course, the vendor-provided application and the generic printer driver of the comparative example do not include the print control program described above. Therefore, in the fax system of the comparative example, the generic printer driver supports only basic fax transmission settings such as paper size, image quality, and color/monochrome, which are standardized by the IPP specification.

As described above, in the comparative example, it is not possible to perform fax transmission using various fax functions unique to the vendor in a printing process using the generic printer driver. In contrast, as described above, according to the present embodiment, in such an environment, it is possible to support vendor-specific functions that cannot be supported by IPP communication among fax functions.

### First Example of FAX Transmission Process

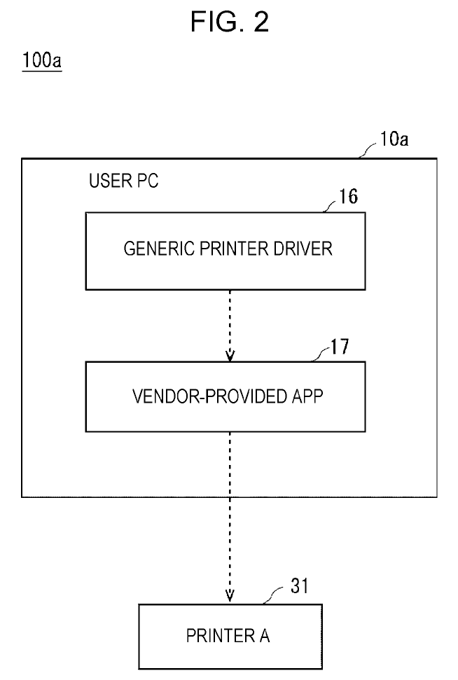

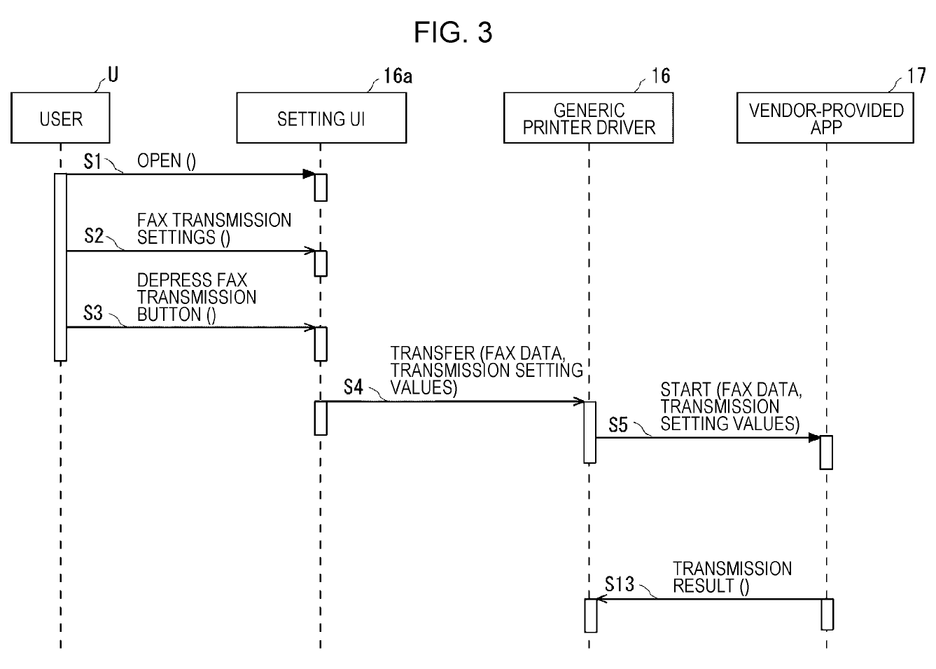

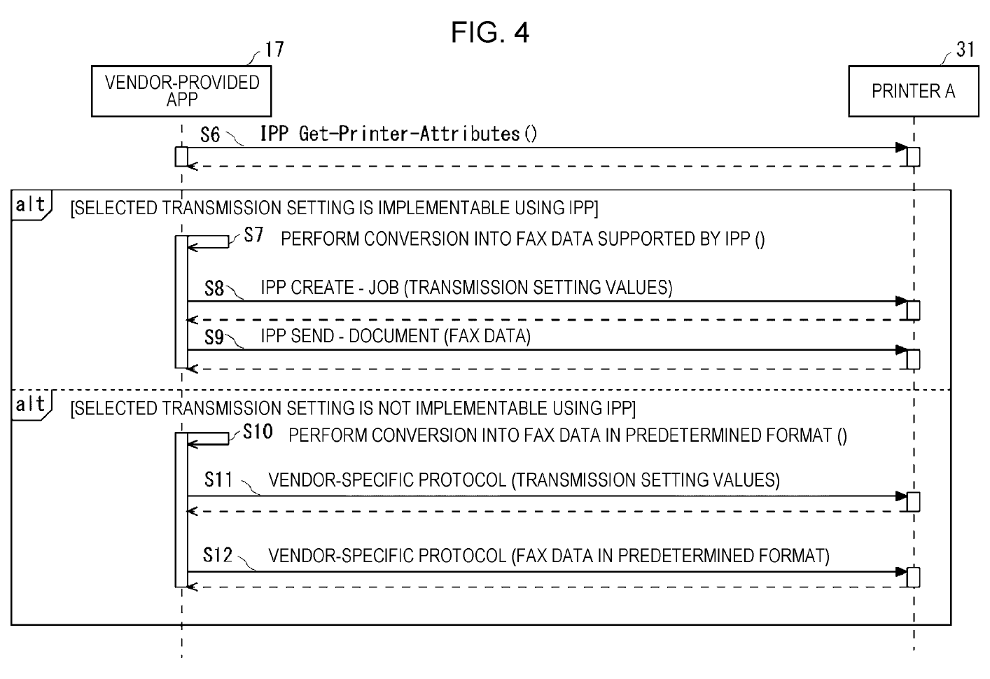

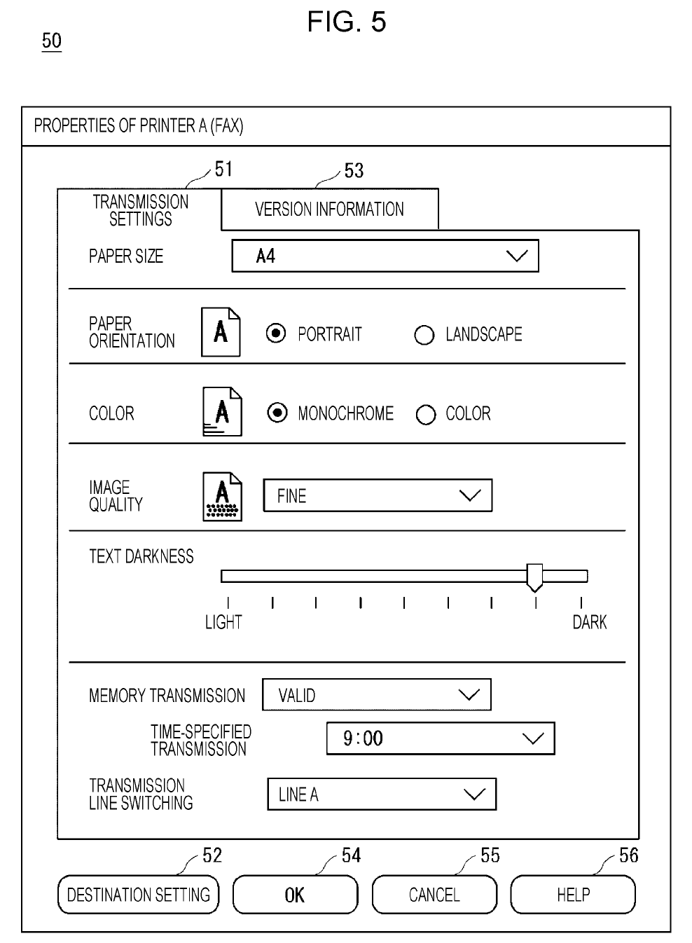

With reference to FIGS. 2 to 5, a first example of the fax transmission process according to the present embodiment will be described. FIG. 2 is a block diagram illustrating a detailed example of a portion of the fax system 100 of FIG. 1 and showing an example of a configuration of a fax system that performs the first example of the fax transmission process. FIG. 3 is a sequence diagram for explaining an example of a fax transmission process performed by the fax system 100 of FIG. 1. FIG. 4 is a sequence diagram for explaining a first example of the fax transmission process executed between steps S5 and S13 of FIG. 3 in the fax system 100a of FIG. 2. FIG. 5 illustrates an example of a UI image displayed in the fax transmission process of FIGS. 3 and 4.

Hereinafter, an example will be described in which the print control program that executes the first acquisition process, the second acquisition process, and the transmission process described above is included in the vendor-provided App 17. In addition, although the following description is given for the case where a request for fax transmission from the terminal device 10 to printer A (31) is made, the same applies to the case where a request for fax transmission to another printer, such as printer B (32) or printer C (33), is made.

As illustrated in FIG. 2, the fax system 100a, which is a first example of the fax system 100, includes a user PC 10a, which is an example of the terminal device 10, and printer A (31). The generic printer driver 16 for the OS and the vendor-provided App 17 are installed in the user PC 10a, and, by using the vendor-provided App 17, a vendor extension process is executed in the background. Through this process, the vendor-provided App 17 transmits the first data to printer A (31). This process is hereinafter referred to as a vendor-extended background process.

First, a user U starts an application program for launching or editing a file to be faxed, such as a document file. Then, in the settings of the file to be faxed, the user U selects printer A (31) having a fax function and performs an operation of selecting a property or another operation from the operation section 14 (step S1). This operation opens a UI image for print settings, including fax transmission settings. In response to this operation, the generic printer driver 16 receives an instruction to start processing, calls a setting UI 16a, and causes the display section 15 to display a UI image for fax settings. As an example of the UI image for fax settings, the UI image 50 illustrated in FIG. 5 will be described hereinafter. Of course, the UI image for fax settings may be an image transitioned from the UI image for print settings by a selection operation performed by the user U.

The UI image 50 includes various fax transmission setting items, as illustrated in a transmission settings tab 51. These items include, as basic setting items, paper size, paper orientation, color/monochrome selection, and image quality. The items displayed in the transmission settings tab 51 may further include, as vendor-specific items, text darkness, the validity or invalidity of memory transmission, a time at which time-specified transmission is performed when memory transmission is valid, and transmission line switching.

If the memory transmission is valid, a fax transmission job is stored in the memory of printer A (31), and the fax transmission is performed as appropriate, for example, after waiting for another job. When the memory transmission is valid and a time for the time-specified transmission is set, the job of fax transmission is stored in the memory of printer A (31), and a fax is transmitted at the specified time. If memory transmission is invalid, it means that the direct transmission, where data of a fax transmission job is directly transmitted without the job being stored in the memory of printer A (31), is selected as an IPP-standard fax function. The transmission line switching item is set to specify a line to be used for transmission when printer A (31) includes multiple fax transmission lines.

Regarding the UI image 50, the basic setting items of the fax transmission settings may be provided by the generic printer driver 16, whereas the other detailed setting items may be provided via the generic printer driver 16 or directly from the vendor-provided App 17 to the setting UI 16a. The UI image 50 may include the basic setting items and a button for transitioning to a UI image for detailed setting items, which are vendor-specific items, and the UI image for detailed setting items may be displayed when the button is selected.

Additionally, the UI image 50 may include a version information tab 53 in which version information is written, an OK button 54, a cancel button 55, and a help button 56. The OK button 54 is selected to store the set contents, close the UI image 50, and transmit a fax transmission instruction to the side of printer A (31). The cancel button 55 is selected to discard the set contents and close the UI image 50. The help button 56 is selected to display a UI image or a site page that provides information to assist the user U during setting on the UI image 50.

Next, the user U performs an operation via the operation section 14 to select various fax transmission settings on the UI image 50, and the setting UI 16a receives the selection operation (step S2). Next, the user U performs an operation via the operation section 14 to select the OK button 54, which is the fax transmission button, on the UI image 50, and the setting UI 16a receives the selection operation (step S3).

Upon receiving a fax transmission request through such a selection operation, the setting UI 16a transfers the fax data to be transmitted and the transmission setting values describing fax transmission setting items to the generic printer driver 16 (step S4). A description of processing such as the setting of a fax transmission destination will be omitted.

Upon receiving these data items, the generic printer driver 16 starts the vendor-extended background process of the vendor-provided App 17, and passes the fax data and the transmission setting values to that process (step S5). The generic printer driver 16 may convert the received fax data before passing the converted fax data to the vendor-extended background process.

Thereafter, a decision and switch process, which will be described later with reference to FIG. 4, is executed between the vendor-provided App 17, which executes the vendor-extended background process, and printer A (31). Then, the generic printer driver 16 receives a fax transmission result from the vendor-provided App 17 (step S13). Thereby, the fax transmission process is completed.

With reference to FIG. 4, a first example of this decision and switch process applied to the first example of the fax transmission process will be described. As described in the first embodiment, the decision and switch process includes the second acquisition process for acquiring capability information for a decision, and the process of switching between IPP and the vendor-specific protocol, which were described earlier as the second acquisition process and the transmission process, respectively. In the present embodiment, such processes enable implementation of the vendor-specific fax transmission function.

In this example, this decision and switch process is executed in the vendor-extended background process. In the decision and switch process, the capability information of printer A (31), that is, the information on configurable settings, is acquired. Then, in the decision and switch process, when the requested function indicated by transmission setting values is not implementable using IPP, or when the requested function is implementable using IPP but IPP implementation of printer A (31), which serves as the transmission destination, is not supported, switching to the vendor-specific protocol is performed. In the first example described here, an example is employed in which communication is directly performed with printer A (31) in the vendor-extended background process.

In the vendor-extended background process, the IPP attributes supported by printer A (31), that is, the information on configurable settings of printer A (31), are acquired using Get-Printer-Attributes of IPP (step S6). The attributes of IPP may be referred to as attribute information of printer A (31) and can indicate any one of, for example, Printer Attribute, Enable Printer, Printer Description Attribute, or the like, which are set as IPP setting values.

If transmission setting values selected by the user U are implementable using IPP, the vendor-extended background process converts the fax data into a fax data format supported by IPP (step S7). Next, in the vendor-extended background process, the transmission setting values are stored in Create-Job of IPP and transmitted to printer A (31) (step S8). Next, in the vendor-extended background process, the fax data is stored in Send-Document of IPP and transmitted to printer A (31) (step S9).

However, if the transmission setting values selected by the user U are not implementable using IPP, the vendor-extended background process converts the fax data into a predetermined fax data format in which the fax data can be transmitted using the vendor-specific protocol (step S10). Next, in the vendor-extended background process, the transmission setting values are transmitted to printer A (31) using the vendor-specific protocol (step S11). Next, in the vendor-extended background process, the converted fax data in the predetermined format is transmitted to printer A (31) using the vendor-specific protocol (step S12).

In the process described above, the communication between the vendor-provided App 17 and printer A (31) may be performed in accordance with, for example, a vendor-extended IPP protocol, SNMP, or another vendor-specific protocol. SNMP stands for Simple Network Management Protocol.

Thereafter, as described with reference to FIG. 3, the vendor-extended background process returns the fax transmission result to the generic printer driver 16 (step S13), and the process is complete.

### Second Example of FAX Transmission Process

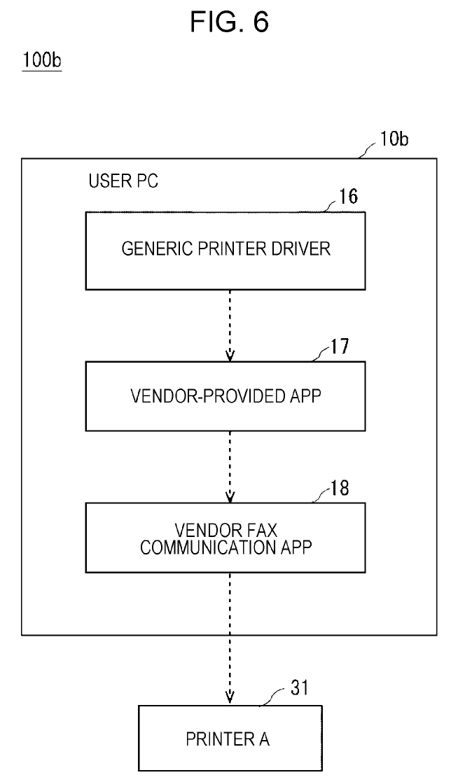

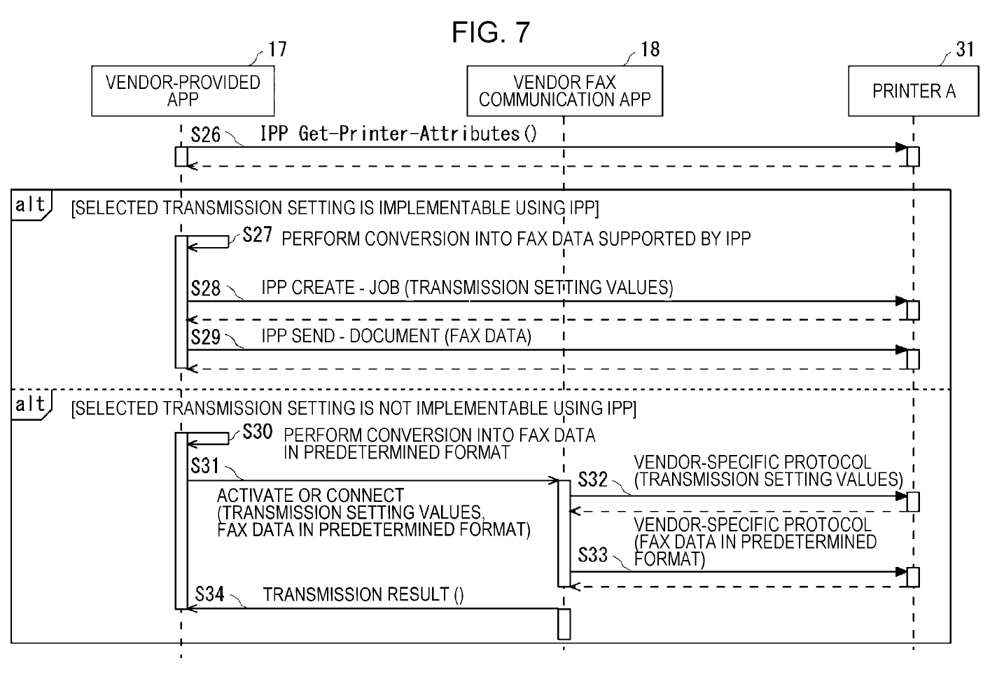

With reference to FIGS. 6 and 7, a second example of the fax transmission process according to the present embodiment will be described. FIG. 6 is a block diagram illustrating a detailed example of a portion of the fax system 100 of FIG. 1 and illustrating a configuration example of a fax system that performs the second example of the fax transmission process. FIG. 7 is a sequence diagram for explaining a second example of the fax transmission process executed between steps S5 and S13 of FIG. 3 in a fax system 100b of FIG. 6. Hereinafter, differences from the first example will be mainly described as the second example, and other points are the same, including the application of various application examples.

In the second example, as in the first example, an example will be described in which the print control program that executes the first acquisition process, the second acquisition process, and the transmission process described above is included in the vendor-provided App 17. In addition, in the second example, similarly to the first example, although the following description is given for the case where a request for fax transmission from the terminal device 10 to printer A (31) is made, the same applies to the case where a request for fax transmission to another printer is made.

As illustrated in FIG. 6, a fax system 100b, which is a second example of the fax system 100, includes a user PC 10b, which is an example of the terminal device 10, and printer A (31). In addition to the generic printer driver 16 of the OS and the vendor-provided App 17, a vendor fax communication App 18 is installed in the user PC 10b. In a vendor-extended background process of the vendor-provided App 17, transmission setting values and fax data are transmitted via the vendor fax communication App 18.

The vendor fax communication App 18 is an example of a providing program that provides a vendor protocol, and is an application program that executes a vendor fax communication process for performing vendor-specific fax communication. As described above, the vendor-provided App 17 in the second example transmits the first data to printer A (31) via the vendor fax communication App 18.

Also in the fax system 100b described above, the process illustrated in FIG. 3 is executed, and the decision and switch process is executed between steps S5 and S13. With reference to FIG. 7, a second example of the decision and switch process applied to the second example of the fax transmission process will be described. This decision and switch process is basically the same as the decision and switch process of the first example, but differs in that the process is executed via the vendor fax communication App 18.

Also in this example, as executed in step S6, in the vendor-extended background process, the IPP attributes supported by printer A (31) are acquired using Get-Printer-Attributes of IPP (step S26).

If the transmission setting values selected by the user U are implementable using IPP, as in steps S7 to S9, the vendor-extended background process executes the same process (steps S27 to S29).

However, if the transmission setting values selected by the user U are not implementable using IPP, as in step S10, the vendor-extended background process converts the fax data into a predetermined fax data format in which the fax data can be transmitted using the vendor-specific protocol (step S30). Next, the vendor-extended background process activates the vendor fax communication App 18 and transmits the transmission setting values and the converted fax data in the predetermined format to the vendor fax communication App 18 (step S31).

The vendor fax communication App 18 may be resident or activated in advance. In this case, in step S31, the vendor-extended background process may connect to the activated vendor fax communication App 18 to perform transmission. As described above, the vendor fax communication process may be activated on demand for each fax transmission or may be resident as a service.

Next, the vendor fax communication App 18 transmits the transmission setting values to printer A (31) using the vendor-specific protocol (step S32). Next, the vendor fax communication App 18 transmits the converted fax data in the predetermined format to printer A (31) using the vendor-specific protocol (step S33).

In the process described above, communication between the vendor fax communication App 18 and printer A (31) may be performed in accordance with, for example, a vendor-extended IPP protocol, SNMP, or another vendor-specific protocol. SNMP stands for Simple Network Management Protocol.

Thereafter, the vendor fax communication App 18 returns the fax transmission result to the vendor-extended background process (step S34). Then, as described with reference to FIG. 3, the vendor-extended background process returns the fax transmission result to the generic printer driver 16 (step S13) and ends the process.

As illustrated in the second example, when the capability information indicates that data transmission using IPP is not possible, the transmission process can be a process of causing the first data to be transmitted to printer A (31) via a providing program such as the vendor fax communication App 18.

The second example is beneficial in the following case. That is, from the viewpoint of security, the second example is beneficial when the user PC 10b is not given authority to directly communicate with printer A (31) via a universal serial bus (USB), a network, or the like in the vendor-extended background process activated by the OS. Here, regarding the USB, it can be determined in accordance with the path whether or not the user PC 10b is given authority. Regarding network communication, for example, when the user PC 10b is a portable PC, it can be determined in accordance with the connected network whether or not the user PC 10b is given the authority. USB stands for Universal Serial Bus and is a registered trademark. In this way, in order to avoid the problem of authority, in the second example, fax transmission is implemented via a vendor fax communication process that provides vendor-specific protocol communication at the time of fax transmission rather than by direct communication from the vendor-extended background process.

In addition, the providing program exemplified by the vendor fax communication App 18 may be incorporated in the vendor-provided App 17. In this case, the transmission process is a process of causing the first data to be transmitted to printer A (31) using the providing program when the capability information indicates that data transmission using IPP is not possible.

### Other Modifications

The present disclosure is not limited to the embodiments described above and may be appropriately modified without departing from the spirit and scope of the disclosure. For example, the system configuration of the fax system, the configuration of each device constituting the fax system, the configuration of each program included in each device, the processing procedure of each device, and the like are not limited to those illustrated. In addition, the fax system may also adopt a network configuration in which a terminal device is connected to a printer via a print server or a fax server. Furthermore, although in the embodiment described above, fax communication using a public telephone line has been described, the present disclosure is not limited to such fax communication. That is, the present disclosure may be applied to a case where fax communication is performed based on standards such as T.30 T.37, T.38, or T.62 of ITU-T. ITU-T stands for International Telecommunication Union Telecommunication Standardization Sector.

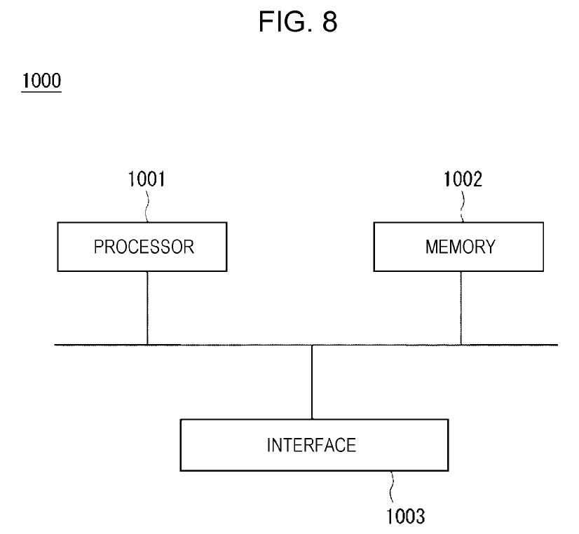

Furthermore, each of the devices provided in the fax system according to the embodiment described above may have, for example, the following hardware configuration. The devices used here include the terminal device, the printers, and the facsimiles in the example of FIG. 1. FIG. 8 is a block diagram illustrating an example of the hardware configuration of each of a device.

A device 1000 illustrated in FIG. 8 may include a processor 1001, a memory 1002, and an interface 1003. The interface 1003 may include, for example, a communication interface and an interface with an input/output device or the like, which are necessary depending on the device.

The processor 1001 may be, for example, a CPU, a GPU, a microprocessor unit (MPU) also referred to as a microprocessor, or the like. The processor 1001 may include a plurality of processors. The memory 1002 may be configured by, for example, a combination of a volatile memory and a nonvolatile memory. The functions of each device are implemented by the processor 1001 reading a program stored in the memory 1002 and executing the program while exchanging necessary information via the interface 1003.

In addition, the program described above includes a command group (or software code) for causing a computer to perform one or more of the functions described in the embodiments when the program is read by the computer. The program may be stored in a non-transitory computer-readable medium or a tangible storage medium. By way of non-limiting examples, the computer-readable medium or the tangible storage medium includes a random-access memory (RAM), a read-only memory (ROM), a flash memory, a solid-state drive (SSD), and other memory technologies. Also, by way of non-limiting examples, the computer-readable medium or the tangible storage medium includes a CD-ROM, a digital versatile disc (DVD), a Blu-ray (registered trademark) disc, and other optical disc storages, a magnetic cassette, a magnetic tape, a magnetic disk storage, and other magnetic storage devices. The program may also be transmitted on a transitory computer-readable medium or a communication medium. By way of non-limiting example, the transitory computer-readable medium or the communication medium includes propagated signals in electrical, optical, acoustical, or other forms.

Although the present disclosure has been described with reference to the embodiments described above, the present disclosure is not limited to the configurations described in the embodiments, and it goes without saying that the present disclosure includes various modifications, corrections, and combinations that can be made by those skilled in the art within the scope of the claims of the present application.

What is claimed is:

1. A non-transitory computer-readable storage medium storing a print control program that causes a computer to execute:
a first acquisition process of acquiring a transmission setting value of a fax from a generic printer driver;
a second acquisition process of acquiring, from an image processing device having a fax transmission function, capability information of the image processing device that is implementable using a first protocol; and
a transmission process of transmitting first data including at least the transmission setting value to the image processing device, using the first protocol, when the capability information indicates that data transmission using the first protocol is possible, and transmitting the first data to the image processing device, using a second protocol defined by a vendor of the image processing device, when the capability information indicates that data transmission using the first protocol is not possible.

2. The non-transitory computer-readable storage medium according to claim 1, wherein the print control program is implemented as a Print Support Application.

3. The non-transitory computer-readable storage medium according to claim 1, wherein the transmission process is a process of causing the first data to be transmitted to the image processing device via a providing program that provides the second protocol, when the capability information indicates that data transmission using the first protocol is not possible.

4. The non-transitory computer-readable storage medium according to claim 1, wherein
the print control program includes a providing program that provides the second protocol, and
the transmission process is a process of causing the first data to be transmitted to the image processing device, using the providing program that provides the second protocol, when the capability information indicates that data transmission using the first protocol is not possible.

5. The non-transitory computer-readable storage medium according to claim 1, wherein the first data includes fax transmission data to be transmitted by the image processing device.

6. An information processing apparatus comprising:
a generic printer driver;
a first acquisition processing unit configured to acquire a transmission setting value of a fax from the generic printer driver;
a second acquisition processing unit configured to acquire, from an image processing device having a fax transmission function, capability information of the image processing device that is implementable using a first protocol; and
a transmission processing unit configured to, when the capability information indicates that data transmission using the first protocol is possible, transmit first data including at least the transmission setting value, using the first protocol, to the image processing device, and to, when the capability information indicates that data transmission using the first protocol is not possible, transmit the first data, using a second protocol defined by a vendor of the image processing device, to the image processing device.

7. A fax transmission method executed by a computer, comprising:
acquiring a transmission setting value of a fax from a generic printer driver;
acquiring, from an image processing device having a fax transmission function, capability information of the image processing device that is implementable using a first protocol; and
transmitting first data including at least the transmission setting value to the image processing device, using the first protocol, when the capability information indicates that data transmission using the first protocol is possible, and transmitting the first data to the image processing device, using a second protocol defined by a vendor of the image processing device, when the capability information indicates that data transmission using the first protocol is not possible.
